(19) United States
(12) Patent Application Publication
(10) Pub. No.: US 2014/0288867 A1
(43) Pub. Date: Sep. 25, 2014

(54) RECALIBRATING AN INERTIAL NAVIGATION SYSTEM

(71) Applicants: Peter C. Karlsson, Lund (SE); Magnus Persson, Flyinge (SE)

(72) Inventors: Peter C. Karlsson, Lund (SE); Magnus Persson, Flyinge (SE)

(73) Assignee: Sony Corporation, Tokyo (JP)

(21) Appl. No.: 13/848,338

(22) Filed: Mar. 21, 2013

(51) Int. Cl. G01P 21/00; G01P 15/00

(52) U.S. Cl. CPC G01P 21/00; G01P 15/00
USPC 702/96

(57) ABSTRACT

A device may include a radio signal receiver, and an inertial navigation system. Additionally, the device may include a processor to determine that the inertial navigation system has been initiated, monitor a radio signal associated with a mobile network received at the radio signal receiver, and determine a channel impulse response (CIR) based on the radio signal. The device may also monitor a Doppler spread of the radio signal based on the CIR in a time domain until a zero Doppler spread is identified. The device may recalibrate the inertial navigation system based on the zero Doppler spread.

### BACKGROUND

Inertial navigation systems (INS systems) calculate the position, orientation, and velocity of a moving object using combinations of different sensors, such as accelerometers and gyroscopes. The accuracy of INS systems is known to decrease because of sensor drift, especially gyro drift, from initial calibration. INS systems may be recalibrated, for example, using zero velocity updates (ZVU). The zero velocity update is provided for a foot mounted inertial measurement unit (IMU) when the user puts down their foot. This allows accuracy to be kept over time with Smartphone grade sensors.

### SUMMARY

In one implementation, a mobile device may a radio signal receiver, an inertial navigation system and a processor for determining that the inertial navigation system has been initiated. The processor may monitor a radio signal associated with a mobile network received at the radio signal receiver and determine a channel impulse response (CIR) based on the radio signal. The processor may monitor a Doppler spread of the radio signal based on the CIR in a time domain to identify a zero Doppler spread. The processor may recalibrate the inertial navigation system based on the identified zero Doppler spread.

In addition, the mobile network may be one of a long term evolution (LTE) network, a code division multiple access (CDMA) network, a global system for mobile communications (GSM) network, a Wi-Fi network, a Bluetooth network, or a wideband code division multiple access (WCDMA) network.

In addition, the inertial navigation system may include one or more gyroscopes, magnetometers, barometers and accelerometers.

In addition, the device may include a mobile phone, a smart phone, a tablet computer, a laptop computer, a personal digital assistant (PDA), and a fitness tracking device.

In addition, when monitoring the radio signal, the processor is further configured to dynamically select the radio signal based on predetermined metrics associated with the radio signal.

In addition, when identifying the zero Doppler spread, the processor may further determine a channel frequency response (CFR) associated with the radio signal, perform an inverse fast Fourier transform to determine the CIR of the radio signal, and monitor the signal amplitude and phase of the CIR until the zero Doppler spread is observed.

In addition, when identifying the zero Doppler spread, the processor may further identify the zero Doppler spread based on a dynamically defined threshold associated the radio signal.

In addition, when identifying the zero Doppler spread, the processor may further determine the Doppler spread based on the following expression:

f_{D}=fc×v/c,

where f_{D} is the Doppler spread, fc is the frequency of the radio signal, v is the velocity of the device, and c is the velocity of the radio signal.

In addition, the processor may be further configured to identify an additional network as a stable clock source.

Additionally, the device may include a graphical user interface capable of receiving instructions to select a network for recalibration of the inertial navigation system.

According to another implementation, a computer-implemented method may include identifying coordinates, of a portion of the touchscreen display.

In addition, the computer-implemented method may further include determining that an inertial navigation system has been initiated, monitoring, by a processor associated with a mobile device, at least one radio signal associated with at least one mobile network received at a radio signal receiver, selecting a recalibration radio signal from the at least one radio signal based on a predetermined recalibration radio signal selection rule, determining a channel impulse response (CIR) based on the recalibration radio signal, monitoring a Doppler spread based on the CIR in a time domain to identify a predetermined Doppler spread, and recalibrating the inertial navigation system based on the predetermined Doppler spread.

In addition, the computer-implemented method may further include determining the predetermined Doppler spread based on a predetermined velocity associated with the device.

In addition, monitoring the at least one radio signal may further include monitoring the recalibration radio signal from one of a long term evolution (LTE) network, a code division multiple access (CDMA) network, a global system for mobile communications (GSM) network, a Wi-Fi network, a Bluetooth network, or a wideband code division multiple access (WCDMA) network.

In addition, the computer-implemented method may further include selecting the recalibration radio signal based on a hierarchy of networks.

In addition, when identifying the zero Doppler spread, the computer-implemented method may further include determining the Doppler spread by applying

f_{D}=fc×v/c,

where f_{D} is the Doppler spread, fc is a current carrier frequency of the recalibration radio signal, v is the velocity of the device, and c is the velocity of the radio signal.

In addition, fc may be one of a frequency for a global system for mobile communications (GSM) network, a frequency for a wideband code division multiple access (WCDMA) network and a frequency for a long term evolution (LTE) network.

In addition, when identifying the predetermined Doppler spread, the computer-implemented method may further include determining a channel frequency response (CFR) associated with the radio signal, performing an inverse fast Fourier transform to determine the CIR of the radio signal, and monitoring the signal amplitude and phase of the CIR until the predetermined Doppler spread is observed.

In addition, when identifying the predetermined Doppler spread, the computer-implemented method may further include determining a channel frequency response (CFR) associated with the radio signal, performing an inverse fast Fourier transform to determine the CIR of the radio signal, and monitoring the signal amplitude and phase of the CIR until the predetermined Doppler spread is observed.

In another implementation, a computer-readable medium including computer-executable instructions, the computer-executable instructions may include instructions to determine that the inertial navigation system has been initiated, monitor a radio signal associated with a mobile network received at the radio signal receiver, determine a channel impulse response (CIR) based on the radio signal, monitor a Doppler spread based on the CIR in a time domain until a zero Doppler spread is identified and recalibrate the inertial navigation system based on the zero Doppler spread.

In addition, the computer-executable instructions may include instructions to be executed by a device that includes one of a mobile phone, a smart phone, a tablet computer, a laptop computer, a personal digital assistant (PDA), or a fitness tracking device.

In addition, the computer-readable instructions include instructions for causing the one or more processors to provide a graphical user interface capable of receiving instructions to select a network for recalibration of the inertial navigation system.

### BRIEF DESCRIPTION OF THE DRAWINGS

The accompanying drawings, which are incorporated in and constitute a part of this specification, illustrate one or more embodiments described herein and, together with the description, explain the embodiments. In the drawings:

FIG. 1 illustrates the concepts described herein;

FIG. 2 is a diagram of an exemplary device that implements the concepts described herein;

FIG. 3 is a block diagram of the device of FIG. 2;

FIG. 4A is a conceptual representation of a zero velocity determination process described herein;

FIG. 4B is a conceptual representation of an inertial navigation system recalibration process described herein; and

FIG. 5 is a flow diagram of an exemplary process for determining zero velocity updates for an inertial navigation system.

### DETAILED DESCRIPTION

The following detailed description refers to the accompanying drawings. The same reference numbers in different drawings may identify the same or similar elements. Also, the following detailed description is exemplary and explanatory only and is not restrictive of the invention, as claimed.

In the following, a mobile device may determine a stationary state based on analysis of a radio signal. In particular, the mobile device may determine the stationary state based on the Doppler Effect on the radio signal with respect to movement of the mobile device. In one implementation, the mobile device may calculate an associated Doppler spread (fD) based on radio channel estimates in time domain, such as the signal amplitude and phase of the channel impulse response (CIR). The mobile device may determine when the mobile device is stationary based on the calculated Doppler spread. The mobile device may then recalibrate an associated inertial navigation system based on the determined stationary state.

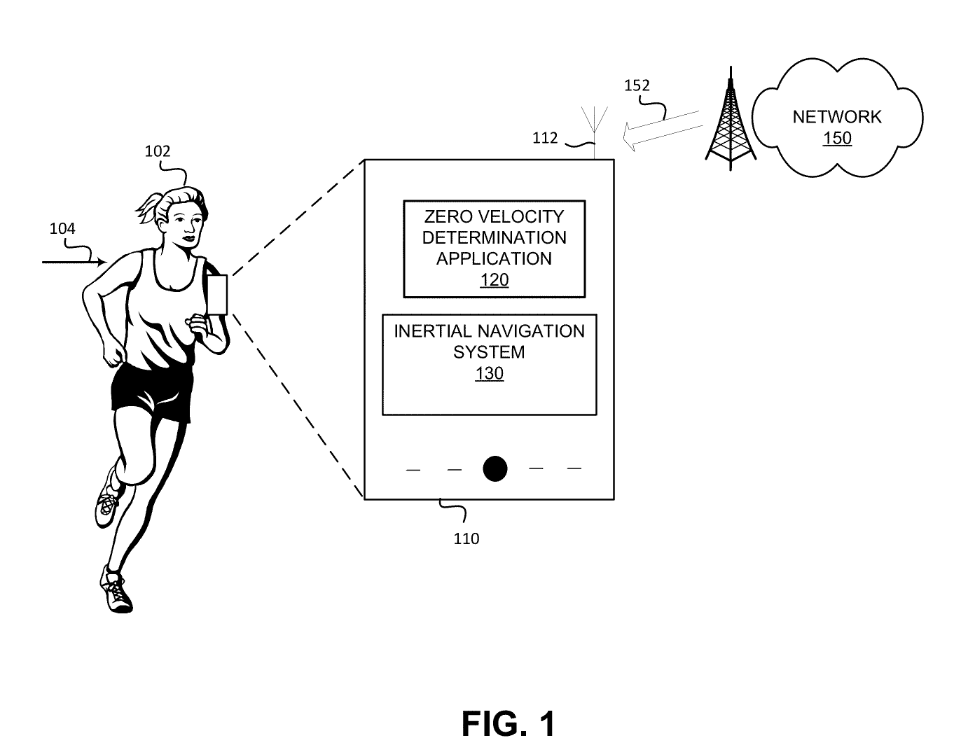

FIG. 1 illustrates an exemplary environment 100 in which systems and/or methods described herein may be implemented. As illustrated, environment 100 may include a user 102 with a mobile device 110. Mobile device 110 may receive radio signals at antenna 112 from a network 150. Although FIG. 1 shows exemplary components of environment 100, in other implementations, environment 100 may include fewer components, different components, differently arranged components, or additional components than depicted in FIG. 1. Additionally or alternatively, one or more components of environment 100 may perform functions described as being performed by one or more other components of environment 100.

As shown in FIG. 1, user 102 may be in motion 104 while carrying a mobile device 110 (e.g., user 100 may hold, wear, etc., mobile device 110 while running, walking, etc.). In this instance, the device's motion 104 is approximately equal to the motion of mobile device 110. Motion 104 may include a velocity (i.e., a speed and a direction) in which user 102 and mobile device 110 may move. Motion 104 may also include an angular motion.

Mobile device 110 may include any portable electronic device with radio communication functionality, such as, for example, a mobile phone, a smart phone, a tablet computer, a laptop computer, a personal digital assistant (PDA), a fitness tracking device or another type of portable electronic device. Mobile device 110 may include a radio signal analysis application 120 and an inertial navigation system 130 as shown in FIG. 1.

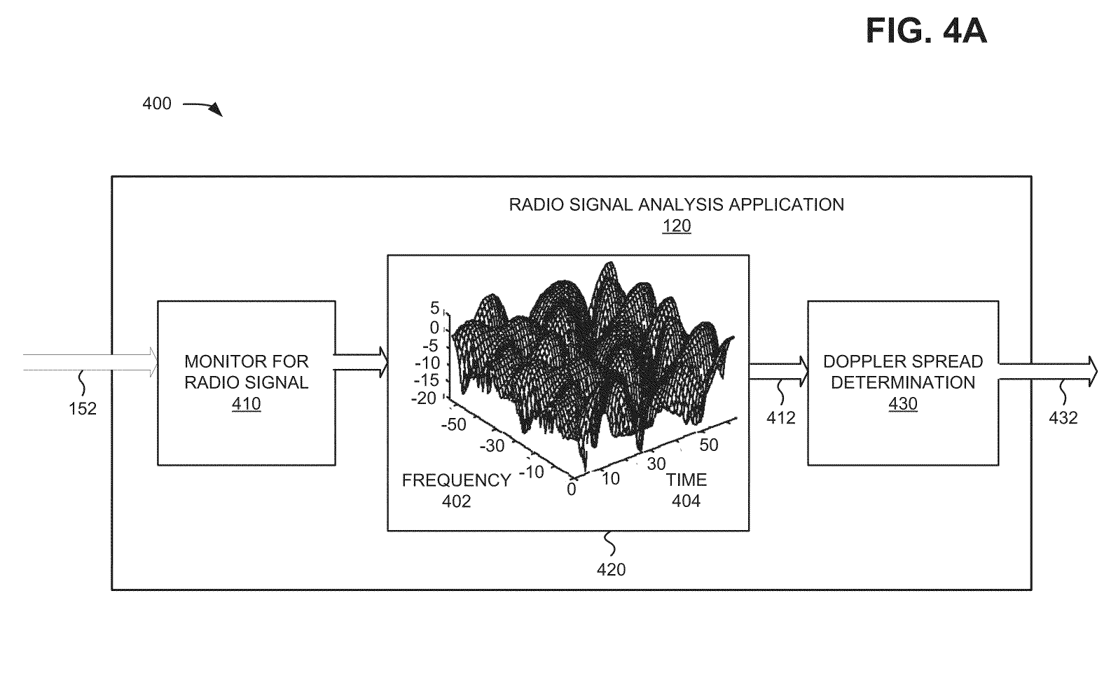

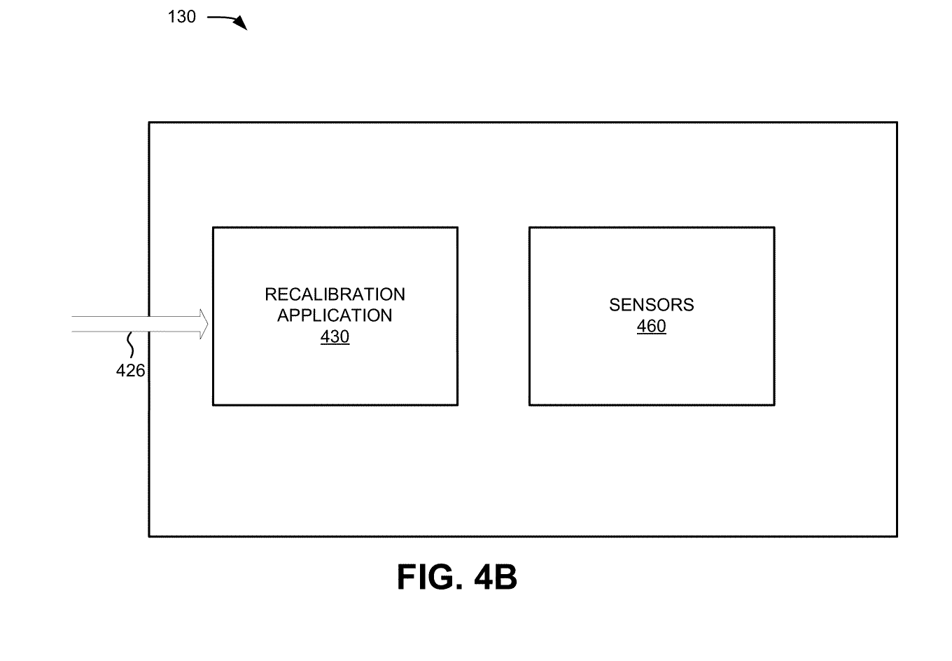

Radio signal analysis application 120 may receive radio signals 152 from network 150 at antenna 112 of mobile device 110. Radio signal analysis application 120 may analyze radio signal 152 to determine a stationary state of mobile device 110 (i.e., that mobile device 110 is currently stationary) as described herein below with respect to FIG. 4A. Radio signal analysis application 120 may identify the phase and amplitude of a radio signal and monitor a state of motion 104 of mobile device 110 to determine when mobile device 110 is stationary. Radio signal analysis application 120 may then send a zero velocity update to inertial navigation system 130.

Inertial navigation system 130 may calculate the position, orientation, and velocity of device 110 using combinations of different sensors, such as accelerometers, magnetometers, barometers and gyroscopes. Inertial navigation system 130 may receive zero velocity updates and recalibrate based on the zero velocity updates as described herein below with respect to FIG. 4B.

Network 150 may provide radio signal 152 that enables mobile device 110 to communicate with other communication devices. Network 150 may include one or more wired and/or wireless networks. For example, network 150 may include a cellular network, the Public Land Mobile Network (PLMN), a second generation (2G) network, a third generation (3G) network, a fourth generation (4G) network (e.g., a long term evolution (LTE) network), a fifth generation (5G) network, a code division multiple access (CDMA) network, a global system for mobile communications (GSM) network, a general packet radio services (GPRS) network, a combination of the above networks, and/or another type of wireless network. Additionally, or alternatively, network 150 may include a local area network (LAN), a wide area network (WAN), a metropolitan area network (MAN), an ad hoc network, an intranet, the Internet, a fiber optic-based network (e.g., a fiber optic service network), a satellite network, a television network, a Wi-Fi network, a Bluetooth network, and/or a combination of these or other types of networks.

In implementations described herein, a system and method of determining a stationary sate of a mobile device based on the phase and amplitude of a received radio signal is disclosed. An inertial navigation system associated with the device may be recalibrated based on the stationary state of the device.

Further, a mobile device may include an inertial navigation system and a processor for providing zero velocity updates to the inertial navigation system based on radio signal analysis. The processor may identify the phase and amplitude of a radio signal and determine a stationary state of the mobile device based on the radio signal analysis. The processor may recalibrate the inertial navigation system based on the zero velocity updates.

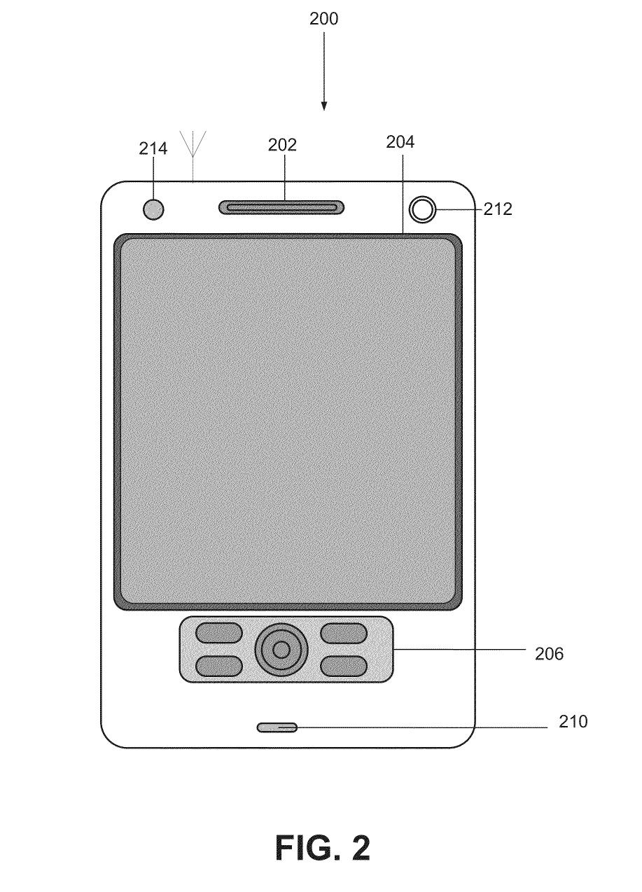

FIG. 2 is a diagram of an exemplary device 200 in which the concepts described herein may be implemented. Device 200 may include any of the following devices: a mobile telephone; a cellular phone; a personal communications system (PCS) terminal that may combine a cellular radiotelephone with data processing, facsimile, and/or data communications capabilities; an electronic notepad, a tablet computer, a laptop, and/or a personal computer; a personal digital assistant (PDA) that can include a telephone; a gaming device or console; a peripheral (e.g., wireless headphone); a digital camera; or another type of computational or communication device that includes an inertial navigation system.

In this implementation, device 200 may take the form of a mobile phone (e.g., a cell phone). As shown in FIG. 2, device 200 may include a speaker 202, a touchscreen display 204, control buttons 206, a microphone 210, sensors 212, a front camera 214, and a housing 216. Speaker 202 may provide audible information to a user of device 200.

Display 204 may provide visual information to the user, such as an image of a caller, video images, or pictures. In addition, display 204 may include a touchscreen for providing input to device 200. Display 204 may provide hardware/software to detect the coordinates of an area that is touched by user 110. For example, display 204 may include a display panel, such as a liquid crystal display (LCD), organic light-emitting diode (OLED) display, and/or another type of display that is capable of providing images to a viewer. Display 204 may include a transparent panel/surface for locating the position of a finger or an object (e.g., stylus) when the finger/object is touching or is close to display 204.

In one implementation, display 204 may generate an electric field at its surface and detect changes in capacitance and the electric field due to a nearby object. A separate processing unit (not shown) that is attached to an output of display 204 may use the output of display 204 to generate the location of disturbances in the electric field, and thus the location of the object (i.e., the touch input).

Control buttons 206 may permit the user to interact with device 200 to cause device 200 to perform one or more operations, such as place or receive a telephone call. In some implementations, control buttons 206 may include a telephone keypad (not shown) that may be complementary to graphical user interface (GUI) objects generated on touchscreen display 204. Microphone 210 may receive audible information from the user. Sensors 212 may collect and provide, to device 200, information (e.g., acoustic, infrared, etc.) that is used to aid the user in capturing images or in providing other types of information (e.g., a distance between a user and device 200). Front camera 214 may enable a user to view, capture and store images (e.g., pictures, video clips) of a subject in front of device 200. Housing 216 may provide a casing for components of device 200 and may protect the components from outside elements.

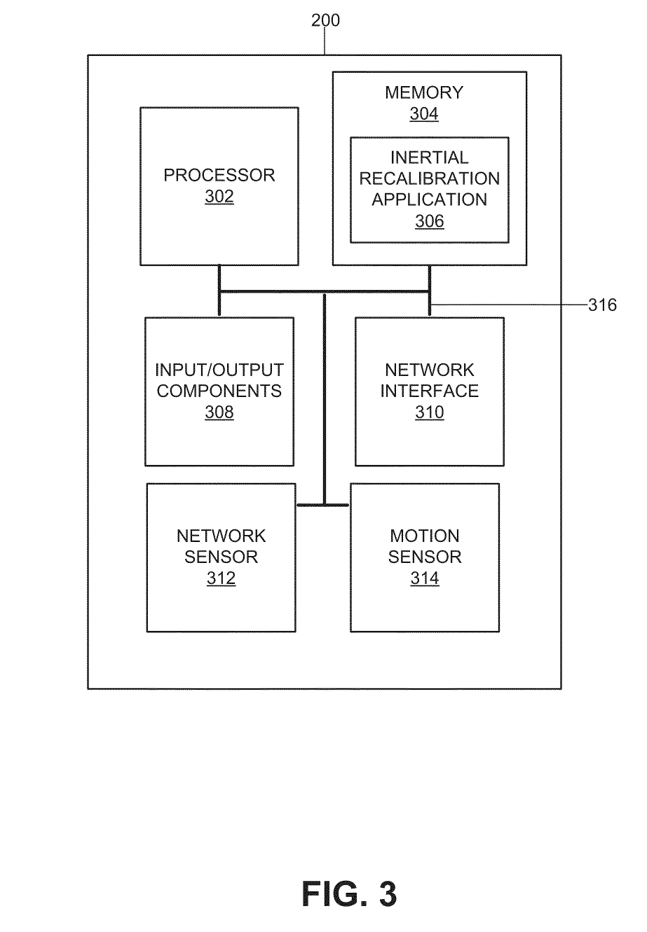

FIG. 3 is a block diagram of the device of FIG. 2. As shown in FIG. 3, device 200 may include a processor 302, a memory 304, input/output components 308, a network interface 310, a touch sensor 312, a inertial sensor 314, and a communication path 316. In different implementations, device 200 may include additional, fewer, or different components than the ones illustrated in FIG. 2. For example, device 200 may include additional network interfaces, such as interfaces for receiving and sending data packets.

Processor 302 may include a processor, a microprocessor, an Application Specific Integrated Circuit (ASIC), a Field Programmable Gate Array (FPGA), and/or other processing logic (e.g., audio/video processor) capable of processing information and/or controlling device 200.

Memory 304 may include static memory, such as read only memory (ROM), and/or dynamic memory, such as random access memory (RAM), or onboard cache, for storing data and machine-readable instructions. Memory 304 may also include storage devices, such as a floppy disk, CD ROM, CD read/write (R/W) disc, and/or flash memory, as well as other types of storage devices.

Memory 304 may include an inertial recalibration application 306. Inertial recalibration application 306 may include data and machine-readable instructions to determine a stationary state of device 200 based on data regarding radio channel estimates. Inertial recalibration application 306 may be executed by processor 302. Inertial calibration application 306 may include machine-readable instructions to execute radio signal analysis application 120 and determine a zero velocity update for device 200. Inertial calibration application 306 may also include machine-readable instructions to recalibrate an inertial navigation system (e.g., inertial sensor 314) associated with device 200 based on the zero velocity update.

Input/output components 308 may include a display screen (e.g., touchscreen display 104, touchscreen display 204, etc.), a keyboard, a mouse, a speaker, a microphone, a Digital Video Disk (DVD) writer, a DVD reader, Universal Serial Bus (USB) lines, and/or other types of components for converting physical events or phenomena to and/or from digital signals that pertain to device 200.

Network interface 310 may include any transceiver-like mechanism that enables device 200 to communicate with other devices and/or systems. For example, network interface 310 may include mechanisms for communicating via a network, such as the Internet, a terrestrial wireless network (e.g., a WLAN), a cellular network, a satellite-based network, a WPAN, etc. Additionally or alternatively, network interface 310 may include a modem, an Ethernet interface to a LAN, and/or an interface/connection for connecting device 200 to other devices (e.g., a Bluetooth interface).

Touch sensor 312 may provide information regarding contact received from user 110 at a particular portion of a touchscreen display of device 200. Touch sensor 312 may be embedded/integrated into touchscreen display 104.

Inertial sensor 314 may include, or be implemented as part of, an inertial navigation system (e.g., inertial navigation system 130) that includes an accelerometer, a magnetometer, a barometer a gyroscope, etc., which provides navigational information regarding motion 104 of device 200. Inertial sensor 314 may continuously calculate the position, orientation, and velocity of device 200 without reliance on an external reference. In one implementation, inertial sensor 314 may determine a position, orientation, and velocity of device 200 using combinations of different sensors, such as accelerometers, magnetometers, barometers and gyroscopes. In another implementation, inertial sensor 314 may determine values associated with motion 104, such as a velocity and direction of device 200 using a multiple coordinate system/reference, such as a Cartesian coordinate system, Euler angles or Tait-Bryan angles, that intersects/overlaps with a conceptual representation of touchscreen display 104 and provide the values to be used in determining adjusted coordinates for a touch input applied to a touchscreen display 204 of device 200. Inertial sensor 314 may determine values that incorporate motion 104 around a center of mass of mobile device 110 including tilt, turn, yaw, pitch, and roll of mobile device 110. Inertial sensor 314 may also determine a change in orientation of touchscreen display 104.

Communication path 316 may provide an interface (e.g., a bus) through which components of device 200 may communicate with one another.

FIG. 4A is a conceptual representation of a zero velocity determination process 400 for a device (e.g., mobile device 110) that may be executed by radio signal analysis application 120. Zero velocity determination process 400 may be initiated when inertial navigation system 130 is requested to track motion 104 associated with user 102 and/or mobile device 110.

As shown in FIG. 4A, zero velocity determination process 400 may include monitoring (block 410) for radio signal 152. For example, mobile device 110 may monitor for available radio signals 152 at antenna 112 (e.g., a radio signal 152 received from a mobile network, such as a GSM, wideband code division multiple access (WCDMA) or LTE network, etc.).

Radio signal analysis application 120 may search for a suitable radio signal to be used in measurement of motion 104 associated with mobile device 110. Radio signal analysis application 120 may search for the radio signal 152 based on a predetermined recalibration signal selection rule, such as a hierarchy of networks, etc. Radio signal analysis application 120 may dynamically select networks, e.g., based on a threshold signal strength, etc. Monitoring for radio signals 152 may have a minimal impact on the power consumption of mobile device 110 in implementations in which the radio signal information is needed in mobile device 110 for other purposes (e.g., radio, communication network, etc.). Radio signal analysis application 120 may monitor for radio signals 152 while having no impact on the radio resources in some implementations as additional signaling may be optional or not needed. Radio signal analysis application 120 may also monitor for additional available radio signals to identify an additional network, such as a Wi-Fi network, as a stable clock source (time 404, as shown in FIG. 4A).

Radio signal analysis application 120 may analyze radio signal 152 and determine a stationary state based on a particular type of network from which radio signal 152 is received.

In one embodiment, radio signal analysis application 120 may identify radio signal 152 from a GSM or WCDMA network. In this instance, radio signal analysis application 120 may identify radio channel estimates in time domain 404, such as the signal amplitude and phase of the channel impulse response (CIR) based on radio signal 152 (420). The CIR may describe the changes in signal processing of radio signal 152 in response to motion 104. Radio signal analysis application 120 may then determine a maximum Doppler shift (of radio signal 152 with regard to motion 104 of user 102) based on the radio channel estimates (430) as follows:

f_{D}=fc×v/c Eqn. (1)
where f_{D} is the Doppler spread (f_{D}),
fc is the frequency of the radio signal 152,
v is the velocity of mobile device 110, and
c is the velocity of the radio signal (i.e., the speed of radio waves in air).
   Doppler spread (f_{D}) is directly proportional to the velocity of mobile device 110 (and, by extension, user 102). Radio signal analysis application 120 may determine a stationary state of mobile device 110 based on Eqn. (1).

In another embodiment, for radio signals 152 received from OFDM based systems, such as LTE and Wi-Fi, radio signal analysis application 120 may determine the channel frequency response (CFR) (420) (i.e., based on observed frequency 402 of radio signal 152). Radio signal analysis application 120 may then obtain the CIR by taking an inverse fast Fourier transform (IFFT) of the channel frequency response (CFR). Radio signal analysis application 120 may then calculate the Doppler spread (f_{D}) for mobile device 110 based on the radio channel estimates in time domain (430) by applying Eqn. (1).

Radio signal analysis application 120 may dynamically define a threshold used to identify if mobile device 110 is stationary based on a current carrier frequency fc of a network used for estimating the channel, e.g. 900 MHz for GSM, 2.1 GHz for WCDMA and 2.6 GHz for LTE. When radio signal analysis application 120 determines that f_{D} is approximately zero, mobile device 110 may be determined to be stationary. When radio signal analysis application 120 identifies with enough reliability that mobile device 110 is stationary, radio signal analysis application 120 may send a zero velocity update indicator to inertial navigation system 130 to be used for recalibration of inertial navigation system 130. In this manner, radio signal analysis application 120 may provide a reliable and accurate reference for inertial navigation system 130 to recalibrate while tracking a user 102 (e.g., moving around indoors) without body placement limitations.

In another implementation, radio signal analysis application 120 may determine recalibration information for inertial navigation system 130 based on a predetermined velocity associated with mobile device 110. For example, mobile device 110 may be associated with motion 104 at a constant velocity and in a predetermined direction (e.g., user 102 may be in motion 104 on a train, ship, etc., which is moving at a constant speed in a constant direction). Radio signal analysis application 120 may determine a reference value to recalibrate mobile device 110 based on the known motion 104 associated with mobile device 110.

FIG. 4B is a conceptual representation of an inertial navigation system recalibration process 450 for a device (e.g., mobile device 110) that may be executed by recalibration application 430 on inertial navigation system 130. Inertial navigation system recalibration process 450 may be initiated when a zero velocity update is received, e.g., from radio signal analysis application 120 (described above with respect to FIG. 4A).

As shown in FIG. 4B, recalibration application 430 may receive a zero velocity update 432. Recalibration application 430 may recalibrate inertial navigation system 130 based on zero velocity update 432. For example, recalibration application 430 may identify sensors 460, which may include gyroscopes, accelerometers, barometers and/or magnetometers.

Recalibration application 430 may identify initial orientation of mobile device 110. For example, recalibration application 430 may identify additional information about an initial horizontal alignment of mobile device 110 and associated components of inertial navigation system 130. Recalibration application 430 may provide initial orientation (i.e., measure exactly a current alignment and heading of inertial navigation system 130) by additional tilt sensors and a compass or by dedicated assumptions applicable to the calibration procedure.

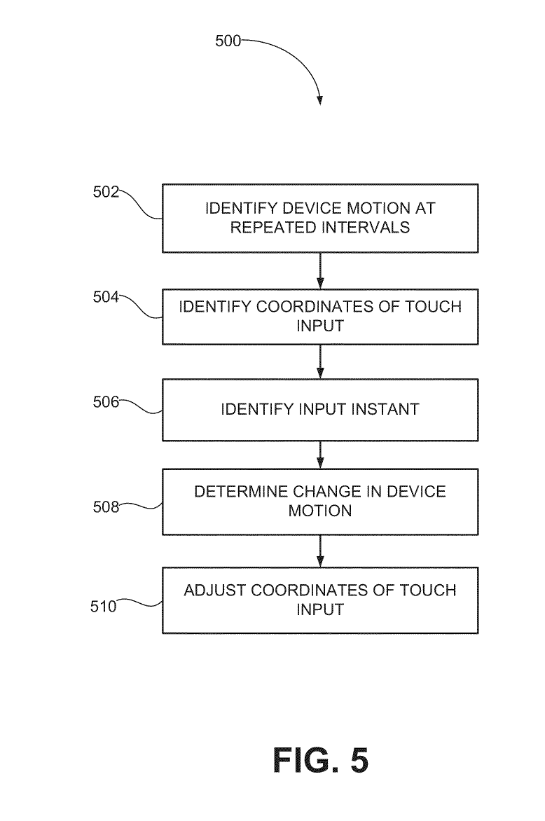

FIG. 5 is a flow chart of an exemplary process for determining zero velocity updates for an inertial navigation system 130 based on radio signal analysis described herein. Process 500 is described with respect to FIG. 5. In one implementation, process 500 may be performed by mobile device 110. In another implementation, some or all of process 500 may be performed by another device or group of devices, including or excluding mobile device 110.

Mobile device 110 may initiate inertial navigation system 130 (block 502). Mobile device 110 may receive an indication that inertial navigation system 130 is to track user movement. For example, user 102 may begin jogging while carrying mobile device 110 and inertial navigation system 130 may identify a velocity and a direction of motion 104.

At block 504, mobile device 110 may identify available radio signals 152. For example, mobile device 110 may access radio resources currently implemented in other applications in mobile device 110. Mobile device 110 may dynamically select radio signal 152 based on predetermined instructions. Alternatively, mobile device 110 may initiate an application to receive radio signals based on radio resources specifically assigned for recalibration of inertial navigation system 130.

At block 506, mobile device 110 may determine a type of network associated with radio signal 152. In one implementation, mobile device 110 may include a GUI that allows user 102 to select a particular network (or type of network) to be used as a reference for recalibration of inertial navigation system 130.

Mobile device 110 may determine a CIR based on the type of radio signal (block 508). For example, for GSM and WCDMA networks, mobile device 110 may determine the CIR in the time domain.

Mobile device 110 may determine a Doppler spread based on the radio channel estimates in time domain associated with motion 104 of mobile device 110 (block 510). For example mobile device 110 may determine the Doppler spread by applying Eqn. (1).

Mobile device 110 may monitor the Doppler spread until a Doppler shift of zero is consistently observed (block 512). For example, mobile device 110 may determine that mobile device 110 is stationary and provide a zero velocity update to inertial navigation system 130. If the Doppler spread is not zero, mobile device 110 may continue to monitor radio signal 152 and the Doppler spread.

Mobile device 110 may recalibrate inertial navigation system 130 based on the zero velocity update (block 514).

The foregoing description of exemplary implementations provides illustration and description, but is not intended to be exhaustive or to limit the embodiments described herein to the precise form disclosed. Modifications and variations are possible in light of the above teachings or may be acquired from practice of the embodiments.

For example, while series of blocks have been described with respect to FIG. 5, the order of the blocks may be modified in other implementations. Further, non-dependent blocks may be performed in parallel.

It will be apparent that different aspects of the description provided above may be implemented in many different forms of software, firmware, and hardware in the implementations illustrated in the figures. The actual software code or specialized control hardware used to implement these aspects is not limiting of the invention. Thus, the operation and behavior of these aspects were described without reference to the specific software code—it being understood that software and control hardware can be designed to implement these aspects based on the description herein.

Although the implementations described above mainly refer to a adjusting touch input of a device based on device motion, in other implementations, other types of input may be adjusted based on motion associated with a receiving device or an input entity.

It should be emphasized that the term “comprises/comprising” when used in this specification is taken to specify the presence of stated features, integers, steps or components but does not preclude the presence or addition of one or more other features, integers, steps, components, or groups thereof.

No element, act, or instruction used in the present application should be construed as critical or essential to the implementations described herein unless explicitly described as such. Also, as used herein, the article “a” is intended to include one or more items. Further, the phrase “based on” is intended to mean “based, at least in part, on” unless explicitly stated otherwise.

What is claimed is:

1. A device comprising:
a radio signal receiver, an inertial navigation system; and
a processor to:
determine that the inertial navigation system has been initiated,
monitor a radio signal associated with a mobile network received at the radio signal receiver,
determine a channel estimation based on the radio signal;
monitor a Doppler spread of the radio signal based on the channel estimation in a time domain to identify a zero Doppler spread; and
recalibrate the inertial navigation system based on the identified zero Doppler spread.

2. The device of claim 1, wherein the mobile network is one of a long term evolution (LTE) network, a code division multiple access (CDMA) network, a global system for mobile communications (GSM) network, a Wi-Fi network, a Bluetooth network, or a wideband code division multiple access (WCDMA) network.

3. The device of claim 1, wherein the inertial navigation system includes one or more gyroscopes and accelerometers.

4. The device of claim 1, wherein the device is includes:
a mobile phone, a smart phone, a tablet computer, a laptop computer, a personal digital assistant (PDA), and a fitness tracking device.

5. The device of claim 1, wherein, when monitoring the radio signal, the processor is further configured to:
dynamically select the radio signal based on predetermined metrics associated with the radio signal.

6. The device of claim 1, wherein, when identifying the zero Doppler spread, the processor is further configured to:
determine a channel frequency response (CFR) associated with the radio signal;
perform an inverse fast Fourier transform to determine the channel estimation of the radio signal, wherein the channel estimation is a channel impulse response (CIR); and
monitor the signal amplitude and phase of the CIR until the zero Doppler spread is observed.

7. The device of claim 1, wherein, when identifying the zero Doppler spread, the processor is further configured to:
identify the zero Doppler spread based on a dynamically defined threshold associated the radio signal.

8. The device of claim 1, wherein, when identifying the zero Doppler spread, the processor is further configured to:
determine the Doppler spread based on the following expression:
f_{D}=fc×v/c,
where f_{D} is the Doppler spread, fc is the frequency of the radio signal, v is the velocity of the device, and c is the velocity of the radio signal.

9. The device of claim 1, wherein the processor is further configured to:
identify an additional network as a stable clock source.

10. The device of claim 1, further comprising:
a graphical user interface capable of receiving instructions to select a network for recalibration of the inertial navigation system.

11. A computer-implemented method comprising:
determining that an inertial navigation system has been initiated;
monitoring, by a processor associated with a mobile device, at least one radio signal associated with at least one mobile network received at a radio signal receiver;
selecting a recalibration radio signal from the at least one radio signal based on a predetermined recalibration radio signal selection rule;
determining a channel impulse response (CIR) based on the recalibration radio signal;
monitoring a Doppler spread based on the CIR in a time domain to identify a predetermined Doppler spread; and
recalibrating the inertial navigation system based on the predetermined Doppler spread.

12. The computer-implemented method of claim 11, further comprising:
determining the predetermined Doppler spread based on a predetermined velocity associated with the device.

13. The computer-implemented method of claim 11, wherein monitoring the at least one radio signal further comprises:
monitoring the recalibration radio signal from one of a long term evolution (LTE) network, a code division multiple access (CDMA) network, a global system for mobile communications (GSM) network, a Wi-Fi network, a Bluetooth network, or a wideband code division multiple access (WCDMA) network.

14. The computer-implemented method of claim 11, further comprising:
selecting the recalibration radio signal based on a hierarchy of networks.

15. The computer-implemented method of claim 11, wherein identifying the zero Doppler spread further comprises:
determining the Doppler spread based on the following expression:
f_{D}=fc×v/c,
where f_{D} is the Doppler spread, fc is a current carrier frequency of the recalibration radio signal, v is the velocity of the device, and c is the velocity of the radio signal.

16. The computer-implemented method of claim 15, wherein fc is one of a frequency for a global system for mobile communications (GSM) network, a frequency for a wideband code division multiple access (WCDMA) network and a frequency for a long term evolution (LTE) network.

17. The computer-implemented method of claim 10, wherein identifying the predetermined Doppler spread, further comprises:
determining a channel frequency response (CFR) associated with the radio signal;
performing an inverse fast Fourier transform to determine the CIR of the radio signal; and
monitoring the signal amplitude and phase of the CIR until the predetermined Doppler spread is observed.

18. A computer-readable medium including instructions to be executed by a processor, the instructions including one or more instructions, when executed by the processor, for causing the processor to:
determine that the inertial navigation system has been initiated,
monitor a radio signal associated with a mobile network received at a radio signal receiver,
determine a channel impulse response (CIR) based on the radio signal;
monitor a Doppler spread based on the CIR in a time domain until a zero Doppler spread is identified; and
recalibrate the inertial navigation system based on the zero Doppler spread.

19. The computer-readable medium of claim 18, wherein the computer-executable instructions include instructions to be executed by a device that includes one of a mobile phone, a smart phone, a tablet computer, a laptop computer, a personal digital assistant (PDA), or a fitness tracking device.

20. The computer-readable medium of claim 18, further comprising instructions for causing the one or more processors to:
provide a graphical user interface capable of receiving instructions to select a network for recalibration of the inertial navigation system.
